(19) United States
(12) Patent Application Publication
(10) Pub. No.: US 2021/0097607 A1
(43) Pub. Date: Apr. 1, 2021

(54) IMPROVED SCORING SYSTEM

(71) Applicant: VISA INTERNATIONAL SERVICE ASSOCIATION, San Francisco, CA (US)

(72) Inventors: Naman Bansal, Bellevue, WA (US); Aditya Kale, Bangalore (IN)

(21) Appl. No.: 16/589,810

(22) Filed: Oct. 1, 2019

(51) Int. Cl. G06Q 40/02

(52) U.S. Cl. CPC G06Q 40/025

(57) ABSTRACT

The present system and method may attempt to look forward and create a more meaningful credit score and related credit report by determining skill and competency of an entity. The system and method may receive a job profile for an entity, may receive course enrollment data for courses the entity is enrolled in and may receive course completion history for the user for courses the entity has completed. A development score may be computed based on the weighted course enrollment data and weighted course completion history and a competency score may be computed based on the job profile of the user. A credit score may be generated for the user using the development score and competency score.

### BACKGROUND

Credit scores have existed for a significant period of time. A credit score may contain information on accounts that an entity may have and the payment status for the entity. The information for each entity may then be analyzed to determine a score which may indicate the credit-worthiness of the entity. However, most credit scores look back in time and fail to anticipate changes which may occur in the future which may be favorable or unfavorable to the credit-worthiness of the entities.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

The present system and method may attempt to look forward and create a more meaningful credit score and related credit report by determining skill and competency of an entity. The system and method may receive a job profile for an entity, may receive course enrollment data for courses the entity is enrolled in and may receive course completion history for the user for courses the entity has completed. A weight may assigned to each course the entity is enrolled in and each course the entity has completed to provide a weighted course enrollment data and a weighted course completion history. A development score may be computed based on the weighted course enrollment data and weighted course completion history and a competency score may be computed based on the job profile of the user. A credit score may be generated for the user using the development score and competency score.

### BRIEF DESCRIPTION OF THE FIGURES

The disclosure may be better understood by references to the detailed description when considered in connection with the accompanying drawings. The components in the figures are not necessarily to scale, emphasis instead being placed upon illustrating the principles of the disclosure. In the figures, like reference numerals designate corresponding parts throughout the different views.

FIG. 1 may be an illustration of a sample credit report;

FIG. 2 may be a flow chart of a disclosed method;

FIG. 3 may be a sample transcript;

FIG. 4 may be an additional sample transcript;

FIG. 5 may be a sample machine learning training set;

FIG. 6A illustrates a machine learning training set being rotated;

FIG. 6B illustrates a machine learning training set being rotated; and

FIG. 7 illustrates a sample computing device physically configured according to the disclosure.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present disclosure now will be described more fully hereinafter with reference to the accompanying drawings, which form a part hereof, and which show, by way of illustration, specific exemplary embodiments by which the disclosure may be practiced. These illustrations and exemplary embodiments are presented with the understanding that the present disclosure is an exemplification and is not intended to be limited to any one of the embodiments illustrated. The disclosure may be embodied in many different forms and should not be construed as limited to the embodiments set forth herein; rather, these embodiments are provided so that this disclosure will be thorough and complete, and will fully convey the scope of the disclosure to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

Credit scores have existed for a significant period of time. A credit score may contain information on accounts that an entity may have and the payment status for the entity. The information for each entity may then be analyzed to determine a score which may indicate the credit-worthiness of the entity. However, most credit scores look back in time and fail to anticipate changes which may occur in the future which may be favorable or unfavorable to the credit-worthiness of the entities.

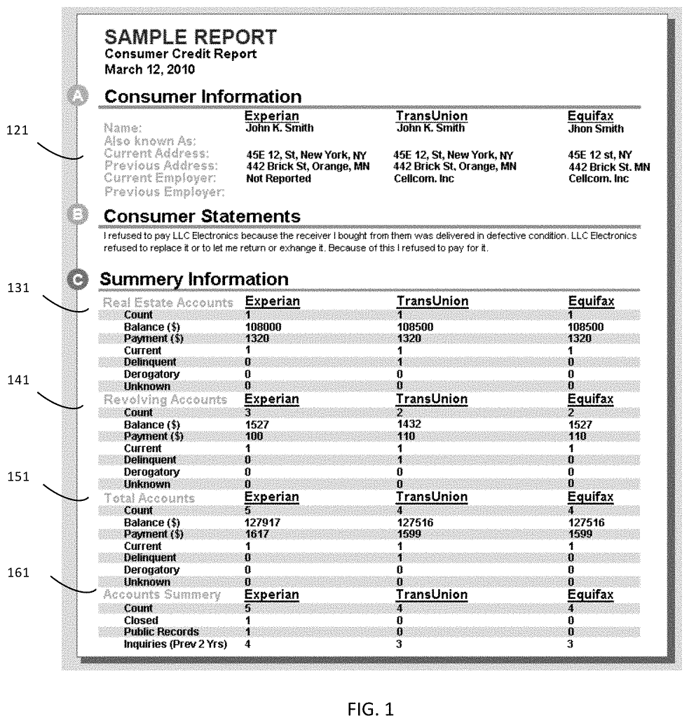

Referring to FIG. 1, a traditional credit report is disclosed 111. Credit reports commonly list known assets, known liabilities and transaction histories for the accounts. It may lists a name 121, real estate accounts 131, revolving accounts 141, total accounts 151 and an account summary 161 from each of the three major credit bureaus. Under each heading are details about the accounts such as count (or number), balance, payments, current amount due, times delinquent, any derogatory comments or unknown comments. All the details and accounts are reviewed to determine a credit score.

The present system and method may attempt to look forward and create a more meaningful credit score and related credit report by determining skill and competency of an entity. The system and method may receive a job profile for an entity, may receive course enrollment data for courses the entity is enrolled in and may receive course completion history for the user for courses the entity has completed. A weight may assigned to each course the entity is enrolled in and each course the entity has completed to provide a weighted course enrollment data and a weighted course completion history. A development score may be computed based on the weighted course enrollment data and weighted course completion history and a competency score may be computed based on the job profile of the user. A credit score may be generated for the user using the development score and competency score.

From a technical standpoint, analyzing the details of the entity is a technical challenge. The course work and test scores do not easily translate into a credit report or a credit score. Thus, new equipment, application programming interfaces, protocols and algorithms may be needed to collect and understand the meaning of courses, the areas of study and the test scores and determine the proper way the courses may affect a credit score. The technical field of credit reports will be improved by the application of the technical system and technical methods described herein.

Entities or users may be analyzed by the system or method. Entities may include for example and not limitation corporations, partnerships, joint ventures and other legal entities that consume goods or services and pay bills for those goods or services. These entities may have credit reports currently. Evaluating entities may be even more challenging as entities are made up of a collection of people and each person may have a different level of skill, education, certification, etc., all of which may play into the ability to rate the entity. In addition, there may be different certifications for entities that may not exist for individuals which may related to the ratings such as ISO certifications or Dun and Bradstreet ratings or S&P ratings. While the inputs to the algorithm and system may be different, the algorithm and system may be designed in such a way to create ratings for entities using the different information that may be available. Related, entities may be broken into smaller groups such as divisions or locations. Logically, the people in the location or division may be reviewed to assist in making credit score determinations about the divisions or locations.

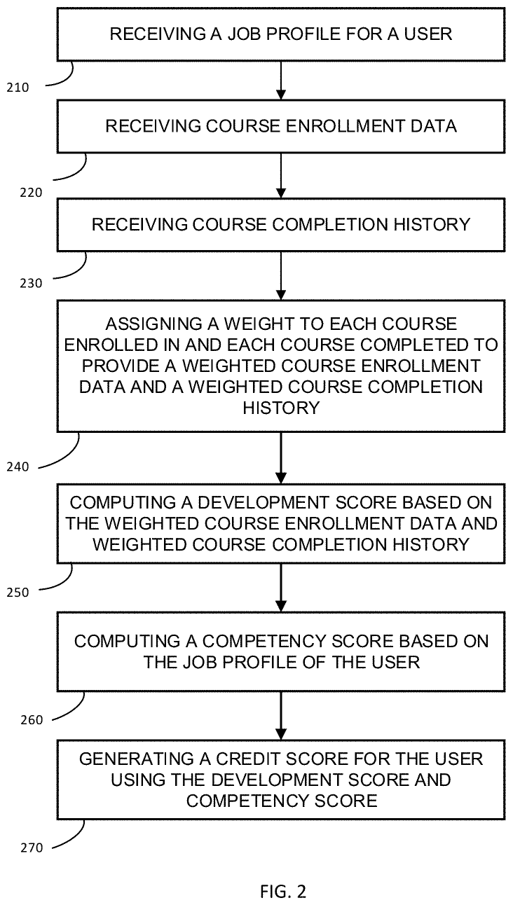

Referring to FIG. 2, at block 210, a job profile for an entity or user may be received. The profile may include one or more of a profession for the user, a user's years of experience in the profession, user's employer, user's current salary, and an average salary for professionals in the profession. If entities are being evaluated, the profile may include the above information for the entity and may also include the type of business, the years the entity has been in business, the parent (if any) of the entity, the profits of the entity measured in a variety of ways, and the average profits for a business in this type of business. Of course, additional data may be used and are contemplated.

At block 220, course enrollment data may be received for courses the user is enrolled in. Course enrollment data may include one or more of a course name, a course type, a course provider, a course instructor, a course number, a course start date, and a course end date. Course enrollment data may also include one or more of a first ranking for the course and a second ranking of a course provider. The rankings may be created by an outside authority or by a plurality of authorities. In some embodiments, a ranking algorithm may be used to create the first ranking and the second ranking. For example, the ranking algorithm may take into account a plurality of rankings from authorities and may determine a composite ranking or a weighting ranking.

Entities also may also be enrolled in certain outside reviews or education courses. For example and not limitation, an entity may pursue ISO qualifications or Six Sigma qualification. Each of the courses may also be given a weight as some course may be more difficult or valuable than other courses. Of course, the weights may be set different according to the end user. Further, the weights may be set by an algorithm.

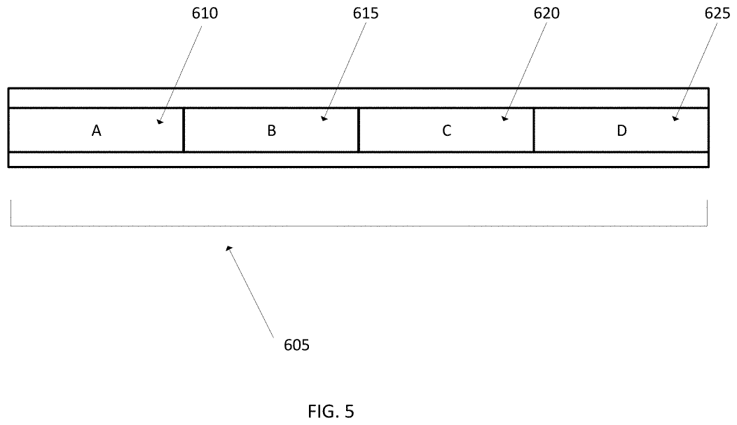

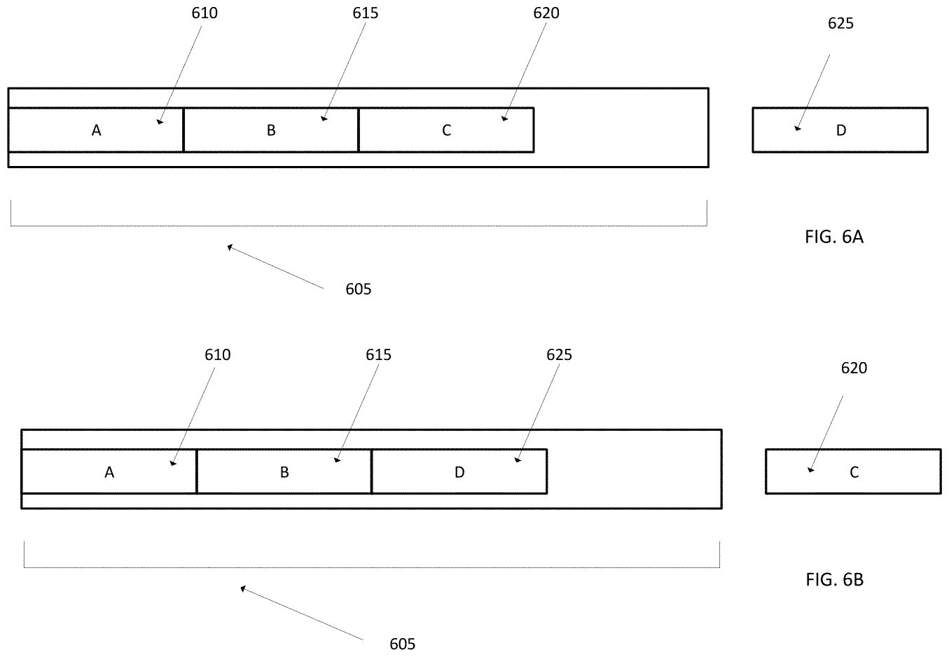

In some embodiments, machine learning may be used to adjust the weights over time such that past weights may be analyzed in view of the resulting credit reports to better determine the most appropriate weights in the future. In some embodiments, the weighting may be refined over time. Machine learning may be used to analyze past weights in view of the actual results of users or entities using credit. Machine learning may be used to review a training group of past weighting data and determine weighting moving forward. FIG. 5 may illustrate sample artificial intelligence (AI) training data according to one or more embodiments. As an example and not a limitation, an artificial intelligence system may trained by analyzing a set of training data 605. The training data may be broken into sets, such as set A 610, set B 615, set C 620 and set D 625. As illustrated in FIG. 6A, one set may be using as a testing set (say set D 625) and the remaining sets may be used as training set (set A 610, set B 615 and set C 620). The artificial intelligence system may analyze the training set (set A 610, set B 615 and set C 620) and use the testing set (set D 625) to test the model create from the training data. Then the data sets may shift as illustrated in FIG. 6B, where the test data set may be added to the training data sets (say set A 610, set B 615 and set D 625) and one of the training data sets that have not been used to test before (say set C 620) may be used as the test data set. The analysis of the training data (set A 610, set B 615 and set D 625) may occur again with the new testing set (set C 620) being used to test the model and the model may be refined. The rotation of data sets may occur repeatedly until all the data sets have been used as the test data sets. The model then may be considered complete and the model may then be used on additional data sets.

At block 230, course completion history may be received for the user for courses the user has completed. The course completion history may include one or more of a course name, a course type, a course provider, a course instructor, a course number, a course start date, a course end date, a first ranking for the course, and a second ranking of the course provider. The course completion history may also include one or more of a degree name, a degree type, a school, a degree start date, a degree completion date, number of credits earned, a first ranking of the degree type, and a second ranking of the school.

In some embodiments, test results related to a job profile may be obtained from relevant platforms such as hackerearth, hackerrank, topcoder, project euler, codechef. The test score also may be factored into the analysis of the course completion history. For example, a user that excelled in a course may be more positively viewed than a user that struggled with a course.

Entities also may receive scores on standards or test. The scores may also be taken into account when evaluating an entity. For example, if it took several attempts for an entity to receive ISO certification, the number of attempts may be factored into the evaluation.

The course related data may be considered sensitive to some users. Thus, permissions may be obtained before obtaining the information. In other embodiments, the data may be gathered from public sources. In yet other embodiments, a combination of public and permission based data may be used. In some embodiments, users may be approached and permission may be requested to obtain the data. For example, if a user wished to improve a credit rating, the rating agency may request additional potentially sensitive data including course enrollment data or course completion data to improve the credit score which may result in loans on more favorable terms. In other situations, course providers may obtain permission from users to release the course information in described circumstances and how the data may be used and the students may have the option to opt out of the disclosure.

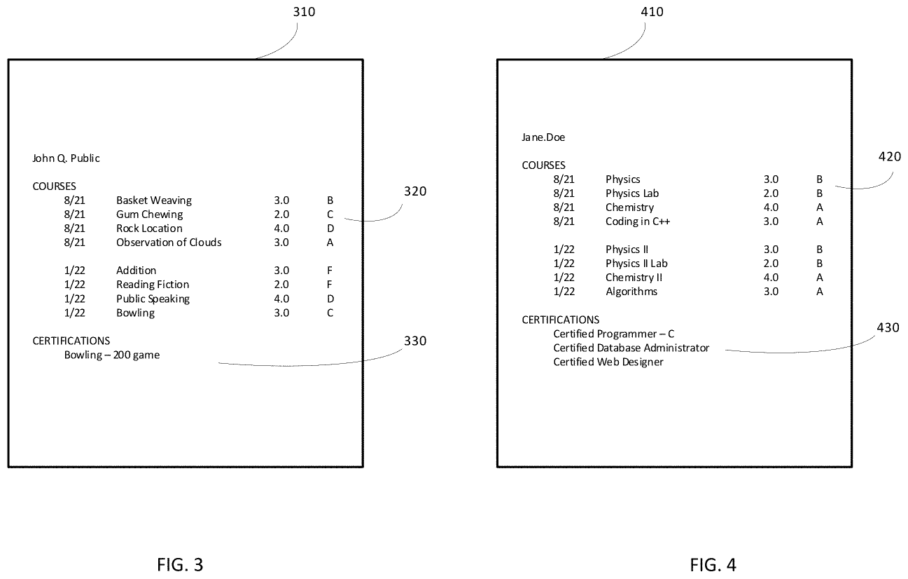

FIG. 3 may be an illustration 310 of a first set of information on classes taken and certifications received by a first user and FIG. 4 may be an illustration 410 of a second set of information on classes taken and certification received by a second user. As is illustrated, John Q. Public in FIG. 3 has taken classes 320 which may be qualified as easier and may be given a lower weight. Jane Doe in FIG. 4 may have taken more challenging classes 420 such as science based classes and these classes may be given a greater weight. Further. John Q. Public in FIG. 3 may have a questionable certification 330 of only bowling a 200 game while Jane Doe may have more significant certification 430 such as being certified as a C programmer, as being a database administrator and as a web designer.

At block 240, a weight may be assigned to each course the user is enrolled in and each course the user has completed to provide a weighted course enrollment data and a weighted course completion history. The weighted course completion history may be based on one or more of the first ranking for the course and the second ranking for the course provider. The weighted course completion history may be based on one or more of the first ranking for the degree type and the second ranking for the school. Logically, the weighted course completion history may take all these mentioned factors into account and each factor may be weighted differently.

Logically, in some embodiments, machine learning such as described in FIGS. 5, 6A and 6B may be used to adjust the weights on the various elements of the courses over time to create more accurate or useful competency scores. For example, some competency scores using a first set of weights may be more useful or accurate than a competency score that uses a second set of weights. By reviewing past weights and competency scores and resulting credit scores, better decisions on weights may be made.

At block 250, a development score may be computed based on the weighted course enrollment data and weighted course completion history. In some situations, completed courses may be considered more valuable and in other situations, courses currently enrolled in may be more important. Thus, the weights on the course enrollment data may be varied.

In some embodiments, machine learning as described in relation to FIGS. 5, 6A and 6B may be used to adjust the weights over time. For example, some development scores using a first set of weights may be more useful or accurate than a development score that uses a second set of weights. By reviewing past weights and development scores and resulting credit scores, better decisions on weights may be made.

At block 260, a competency score may be determined based on the job profile of the user. The various elements of the job profile from block 210 such as one or more of a profession for the user, a user's years of experience in the profession, user's employer, user's current salary, and an average salary for professionals in the profession may be evaluated and a score may be determined.

The competency score may also evaluate user learning history on paid/unpaid learning websites. If the user lists such information or the information is publically available, it may be used to further establish a competency score. Some sample learning platforms may include platforms (such as Coursera, ed.X, Khan Academy, etc.). The cumulative competency may then be used to adjust a credit score.

In some embodiments, machine learning as described in FIGS. 5, 6A and 6B may be used to adjust the weights on the various elements of the job profile over time to create more accurate or useful competency scores. For example, some competency scores using a first set of weights may be more useful or accurate than a competency score that uses a second set of weights. By reviewing past weights and competency scores and resulting credit scores, better decisions on weights may be made.

At block 270, a credit score may be generated for the user using the development score from block 250 and competency score from block 260. In some embodiments, an algorithm is used to compute the credit score using the user development score and competency score as inputs. The algorithm may give equal weights to each input or one input may be given more weight than another depending on the end user.

Logically, in some embodiments, machine learning as described in FIGS. 5, 6A and 6B may be used to adjust the weights on the development score and the competency score over time to create more accurate or useful credit scores. For example, some credit scores using a first set of weights may be more useful or accurate than a credit score that uses a second set of weights. By reviewing past weights and credit scores, better decisions on weights may be made.

In some embodiments, additional information may be used to create the credit score. In some embodiments, personal information may be used if available. The personal information may include an age of the user and an address. In an additional embodiment, the personal information may include one or more of frequent flyer miles for the user and flight history. In yet another embodiment, the personal information may include one or more of a payment account history, a length of payment account history, a payment amount owed, a type of payment account, a number of payment accounts, a number of transactions, an amount of credit used, and available credit.

In yet another embodiment, publicly available data on what people with particular certifications or coursework earn may be publically available. For example, the average income of individuals with a Microsoft Solutions Developer certification may be known. Further, the data may spread across time such as a first year MSD holder may earn $ X per year and a five year MSD holder may earn $ Z per year. Similarly, historical data on earning based on classwork undertaken or completed may be known and may be used by the system. The salary data may more accurately help determine a credit rating for an individual or an entity.

In some embodiments, APIs may be used to obtain a credit score. In one embodiment, data on a person or entity may be communicated to the improved credit score system and in response a credit score may be received. The API may be communicated according to a known protocol and the response may be received in an expected protocol. One aspect of the protocol may include an indication that the improved system and algorithm that uses work skill and experience be used. For example, a request for a normal credit score may contain the following items;
a first name,
a last name,
an address and
an identification number such as a social security number where each.

Each item may be in a field of a known length and in a known order according to a known protocol. A request for the advanced credit report using classes and employment history may include an additional field to indicate that the advanced credit report is requested.

In some embodiments APIs and protocols may be used to update a credit report with information about classes taken, grades earned and certifications earned. The protocol may have fields for classes to be listed, grades to be listed and certifications earned to be listed. The length and order of the fields may be known and may be made available to the public by the publication of a protocol. A user interface may gather the data, the data may be stored in accordance with the protocol and the data may be communicated to the system using the API where the data will be parsed according to the protocol and added to the credit report where it may then be analyzed to create a more advanced credit score.

By implementing the teachings of the disclosure, a system may be constructed that better analyzes the creditworthiness of individuals and entities. Thus, the payment service system may provide a technical solution to the problem of making efficient and improved credit decisions on individuals and entities.

While the present disclosure may be embodied in many different forms, the drawings and discussion are presented with the understanding that the present disclosure is an exemplification and is not intended to be limited to any one of the embodiments illustrated.

The present disclosure provides a solution to the long-felt need described above. In particular, the system and the methods described herein may be configured to efficiently provide efficient determination of current credit worthiness based on courses and certifications. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

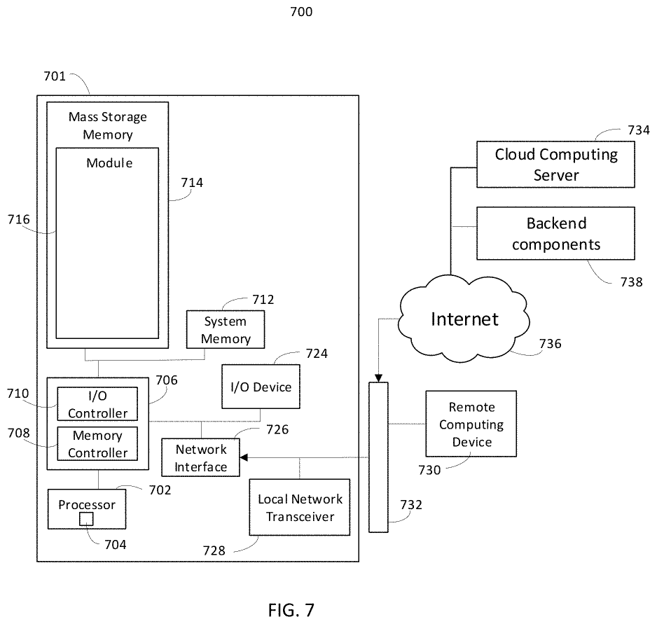

As noted, many computers may be used by the system. FIG. 7 may illustrate a sample computing device 701. The computing device 701 includes a processor 702 that is coupled to an interconnection bus. The processor 702 includes a register set or register space 704, which is depicted in FIG. 7 as being entirely on-chip, but which could alternatively be located entirely or partially off-chip and directly coupled to the processor 702 via dedicated electrical connections and/or via the interconnection bus. The processor 702 may be any suitable processor, processing unit or microprocessor. Although not shown in FIG. 7, the computing device 901 may be a multi-processor device and, thus, may include one or more additional processors that are identical or similar to the processor 702 and that are communicatively coupled to the interconnection bus.

The processor 702 of FIG. 7 is coupled to a chipset 706, which includes a memory controller 708 and a peripheral input/output (I/O) controller 710. As is well known, a chipset typically provides I/O and memory management functions as well as a plurality of general purpose and/or special purpose registers, timers, etc. that are accessible or used by one or more processors coupled to the chipset 706. The memory controller 708 performs functions that enable the processor 702 (or processors if there are multiple processors) to access a system memory 712 and a mass storage memory 714, that may include either or both of an in-memory cache (e.g., a cache within the memory 712) or an on-disk cache (e.g., a cache within the mass storage memory 714).

The system memory 712 may include any desired type of volatile and/or non-volatile memory such as, for example, static random access memory (SRAM), dynamic random access memory (DRAM), flash memory, read-only memory (ROM), etc. The mass storage memory 714 may include any desired type of mass storage device. For example, the computing device 701 may be used to implement a module 716 (e.g., the various modules as herein described). The mass storage memory 714 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 701, the systems and methods described herein. Thus, a module, block, function, operation, procedure, routine, step, and method can be implemented in hardware, firmware, and/or software. In one embodiment, program modules and routines are stored in mass storage memory 714, loaded into system memory 712, and executed by a processor 702 or can be provided from computer program products that are stored in tangible computer-readable storage mediums (e.g. RAM, hard disk, optical/magnetic media, etc.).

The peripheral I/O controller 710 performs functions that enable the processor 702 to communicate with a peripheral input/output (I/O) device 724, a network interface 726, a local network transceiver 728, (via the network interface 726) via a peripheral I/O bus. The I/O device 724 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 724 may be used with the module 716, etc., to receive data from the transceiver 728, send the data to the components of the system 100, and perform any operations related to the methods as described herein. The local network transceiver 728 may include support for a Wi-Fi network, Bluetooth, Infrared, cellular, or other wireless data transmission protocols. In other embodiments, one element may simultaneously support each of the various wireless protocols employed by the computing device 701. For example, a software-defined radio may be able to support multiple protocols via downloadable instructions. In operation, the computing device 701 may be able to periodically poll for visible wireless network transmitters (both cellular and local network) on a periodic basis. Such polling may be possible even while normal wireless traffic is being supported on the computing device 701. The network interface 726 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 708 and the I/O controller 710 are depicted in FIG. 7 as separate functional blocks within the chipset 706, the functions performed by these blocks may be integrated within a single integrated circuit or may be implemented using two or more separate integrated circuits. The computing environment 700 may also implement the module 716 on a remote computing device 730. The remote computing device 730 may communicate with the computing device 701 over an Ethernet link 732. In some embodiments, the module 716 may be retrieved by the computing device 701 from a cloud computing server 734 via the Internet 736. When using the cloud computing server 734, the retrieved module 716 may be programmatically linked with the computing device 701. The module 716 may be a collection of various software platforms including artificial intelligence software and document creation software or may also be a Java® applet executing within a Java® Virtual Machine (JVM) environment resident in the computing device 701 or the remote computing device 730. The module 716 may also be a “plug-in” adapted to execute in a web-browser located on the computing devices 701 and 730. In some embodiments, the module 716 may communicate with back end components 738 via the Internet 736.

The system 700 may include but is not limited to any combination of a LAN, a MAN, a WAN, a mobile, a wired or wireless network, a private network, or a virtual private network. It is understood that any number of client computers are supported and can be in communication within the system 700.

Additionally, certain embodiments are described herein as including logic or a number of components, modules, blocks, or mechanisms. Modules and method blocks may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a processor configured using software, the processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

We claim:

1. A computer-implemented method for determining a credit score, comprising:
receiving a job profile for a user;
receiving course enrollment data for courses the user is enrolled in;
receiving course completion history for the user for courses the user has completed;
assigning a weight to each course the user is enrolled in and each course the user has completed to provide a weighted course enrollment data and a weighted course completion history;
computing a development score based on the weighted course enrollment data and weighted course completion history;
computing a competency score based on the job profile of the user; and,
generating a credit score for the user using the development score and competency score.

2. The method of claim 1, wherein the development score and competency score are each equally incorporated into the credit score.

3. The method of claim 1, wherein the job profile includes one or more of a profession for the user, a user's years of experience in the profession, user's employer, user's current salary, and an average salary for professionals in the profession.

4. The method of claim 1, wherein the course enrollment data includes one or more of a course name, a course type, a course provider, a course instructor, a course number, a course start date, and a course end date.

5. The method of claim 1, wherein the course enrollment data includes one or more of a first ranking for the course and a second ranking of a course provider.

6. The method of claim 5, wherein the weighted course enrollment data is based on the first ranking for the course or the second ranking for the course provider.

7. The method of claim 1, wherein the course completion history includes one or more of a course name, a course type, a course provider, a course instructor, a course number, a course start date, a course end date, a first ranking for the course, and a second ranking of the course provider.

8. The method of claim 7, wherein the weighted course completion history is based on one or more of the first ranking for the course and the second ranking for the course provider.

9. The method of claim 1, wherein the course completion history includes one or more of a degree name, a degree type, a school, a degree start date, a degree completion date, number of credits earned, a first ranking of the degree type, and a second ranking of the school.

10. The method of claim 9, wherein the weighted course completion history is based on one or more of the first ranking for the degree type and the second ranking for the school.

11. The method of claim 1, further comprising:
receiving personal information for the user.

12. The method of claim 11, further comprising,
generating the credit score for the user using the personal information in addition to the development score and competency score.

13. The method of claim 11, wherein the personal information includes an age of the user and an address.

14. The method of claim 11, wherein the personal information includes one or more of frequent flyer miles for the user and flight history.

15. The method of claim 11, wherein the personal information includes one or more of a payment account history, a length of payment account history, a payment amount owed, a type of payment account, a number of payment accounts, a number of transactions, an amount of credit used, and available credit.

16. The method of claim 1, wherein the method is performed via an application interface program (API).

17. A processor-readable non-transitory medium storing processor-issuable instructions configured to cause a processor to:
receive a job profile for a user;
receive course enrollment data for courses the user is enrolled in;
receive course completion history for the user for courses the user has completed;
assign an enroll weight to each course the user is enrolled in to create weighted course enrollment data;
assign a completed weight to each course the user has completed to create weight course completed data;
compute a development score based on the weighted course enrollment data and the weighted course completion history;
compute a competency score based on the job profile of the user; and,
generate a credit score for the user using the development score and competency score.

18. The processor-readable non-transitory medium of claim 17, wherein the development score and competency score are each equally incorporated into the credit score.

19. A system for determining a credit score, comprising:
a processor, wherein the processor is configured to:
receive a job profile for a user;
receive course enrollment data for courses the user is enrolled in;
receive course completion history for the user for courses the user has completed;
assign an enroll weight to each course the user is enrolled to create weighted course enrollment data;
assign a completed weight to each course the user has completed to create weighted course completed data;
compute a development score based on the weighted course enrollment data and the weighted course completion history;
compute a competency score based on the job profile of the user; and,
generate a credit score for the user using the development score and competency score.

20. The system of claim 19, wherein the development score and competency score are each equally incorporated into the credit score.
